(19) United States
(12) Patent Application Publication
(10) Pub. No.: US 2006/0119365 A1
(43) Pub. Date: Jun. 8, 2006

(54) Testing apparatus and method for vehicle starting and charging system

(76) Inventor: Surender Makhija, Brookfield, WI (US)

Correspondence Address: BAKER & HOSTETLER LLP;Washington Square, Suite 1100, 1050 Connecticut Avenue, N.W., Washington, DC, 20036, US

(21) Appl. No.: 11/004,989

(22) Filed: Dec. 7, 2004

(51) Int. Cl. F02P 17/00

(52) U.S. Cl. 324/380

(57) ABSTRACT

A method and apparatus for testing a vehicle starting and charging system is provided in which a smart test module is connected to a remote device such as a battery tester, a scan tool, a personal computer or a personal digital assistant. The remote device is connected to a power source, which power source additionally provides power to the smart test module via the remote device. An alternator and/or a starter motor assembly is connected to the smart test module. The smart test module is capable of controlling the alternator field current and making voltage and current measurements at prescribed test points in the vehicle starting and charging system.

### FIELD OF THE INVENTION

The present invention relates generally to electronic test equipment. More particularly, the present invention relates to a test module to diagnose problems in vehicle starting and charging systems.

### BACKGROUND OF THE-INVENTION

Many vehicles have engine starting and electrical charging systems. The purpose of the charging system is to provide the electrical energy needed to charge the battery and to power all the electrical components and systems on the automobile. When the engine is not running, the battery provides this electrical energy. When the engine is running, the charging system takes over since the automotive storage battery is not capable of supplying the demands of the electrical system for an extended period of time.

Most vehicles are equipped with a means of replacing the current being drawn from the battery. A charging system is used to restore the electrical power to the battery that was used during engine starting. In addition, charging systems are generally designed to react quickly to high load demands required of the electrical system. It is the charging system of the vehicle that generates the current to operate all of the electrical accessories while the engine is running.

Thus, in an event of charging system failure, it may be important to identify the source of any problem(s) within the charging system. While conventional battery and starting charging system testers may be able to diagnose a state of a starting and/or charging system in a vehicle, they do not do an adequate job of diagnosing an actual component including, for instance, an alternator, a regulator, a starter, associated wiring, and/or connections.

Accordingly, it is desirable to provide a method and apparatus that not only provides an analysis of starting and/or charging systems in vehicles, but also diagnoses components of the starting and/or charging system.

### SUMMARY OF THE INVENTION

The foregoing needs are met, to a great extent, by the present invention, wherein in one aspect an apparatus for testing a vehicle starting and charging system is provided that in some embodiments includes a test module, a remote device connected to the test module, a power source connected to the remote device wherein the test module draws power from the power source through the remote device connection. The method may also include an alternator and/or a starter motor assembly connected to the test module.

In accordance with another aspect of the present invention, a method of testing a vehicle starting and charging system is provided that in some embodiments includes providing a smart test module to test an alternator and/or starter motor assembly. The method may also include connecting the smart test module to a remote device, connecting the remote device to a power source and powering the smart test module through the remote device. The method also provides connecting a starter motor assembly and/or an alternator to the smart test module.

In accordance with yet another aspect of the present invention, a system for testing a vehicle starting and charging system is provided that in some embodiments includes a means for testing an alternator and/or starter motor assembly, a means for connecting the testing means to a remote device, a means for connecting the remote device to a means for providing power to power the testing means through the remote device. The system may also include a means for connecting a starter motor assembly and/or an alternator to the testing means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating an example of a starting and charging system in a vehicle.

FIG. 2 is a cutaway view of a an example of a starter motor assembly.

FIG. 3 is a hardware schematic design illustrating a preferred embodiment of the invention.

FIG. 4 is a hardware schematic design illustrating alternate embodiments of the invention.

### DETAILED DESCRIPTION

The invention will now be described with reference to the drawing figures, in which like reference numerals refer to like parts throughout. An embodiment in accordance with the present invention provides a tester such as a smart test module that not only provides an analysis of starting and/or charging systems in vehicles, but also diagnoses components of the starting and/or charging system. In a preferred embodiment, the smart test module is capable of controlling the alternator field current and making the required voltage measurements at given test points in a starting and/or charging system of a vehicle. The smart test module is further capable of communicating with a remote device such as a convention battery tester, a scan tool device, a personal computer (PC), or a personal digital assistant (PDA). A user interface and data base information may reside in any of the aforementioned devices and may be further downloaded to the smart test module through a communication port.

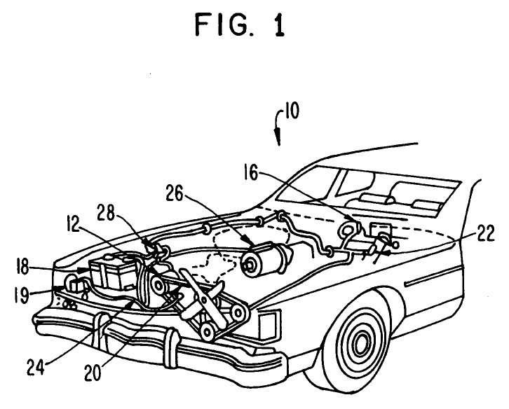

A primary purpose of the charging system includes providing the electrical energy needed to charge the battery and to power all the electrical components and systems on the automobile. When the engine is not running, the battery provides this electrical energy. When the engine is running, the charging system takes over. Some basic parts of a charging system 10 are illustrated in FIG. 1. A charging device 12, such as an alternator, for example, is the heart of the charging system. In a preferred embodiment, the charging device 12 is an alternating-current (AC) generator which can be mounted on the engine and configured to be driven by a belt 20 from a crankshaft. The alternator 12 develops alternating current which changes from positive to negative at a regular cycle. In the prescribed set-up, alternating current is converted to direct current in order to charge a battery.

A voltage regulator 14, either inside or outside the alternator, works to sense the electrical needs of the vehicle and adjusts the output of the alternator 12 accordingly. An indicator light 16 on the instrument panel allows the driver to observe whether the charging system 10 is operating properly. The battery 18 is connected electrically to the alternator 12 so that either one may supply the electrical needs and also so that the alternator 12 can charge the battery 18.

During vehicle operation, as the battery drain continues, and engine speed increases, the charging system 10 is able to produce more voltage which is generally higher than the battery voltage. Thus, the charging device 12 supplies the load requirements of the electrical system.

If there is an increase in the electrical demand and a drop in the output of the charging system 10 equal to the voltage of the battery 18, the battery 18 and charging system 10 work together to supply the required current. Components of the charging system 10 may include the battery 18, an AC generator 12, a drive belt 20, a voltage regulator 14, a charge indicator (lamp or gauge) 16, an ignition switch 22, and cables or a wiring harness 24. A starter relay 26 and a fusible link may also be used in some systems.

In general, the charging system 10 is designed to use the principle of electromagnetic induction to generate electrical power. A function of the drive belt includes turning a conductor. Electromagnetic principle states that a voltage will be produced if motion between a conductor and a magnetic field occurs. The amount of voltage produced is affected by: (1) the speed at which the conductor passes through the magnetic field, (2) the strength of the magnetic field, and (3) the number of conductors passing through the magnetic field.

When a conductor is parallel with the magnetic field, the conductor is not cut by any flux lines. At this point in the revolution there is zero voltage and current being produced. As the conductor is rotated 90 degrees, the magnetic field is at a right angle to the conductor. At this point in the revolution the maximum number of flux lines cut the conductor at the north pole. With the maximum amount of flux lines cutting the conductor, voltage and current are at maximum positive values. When the conductor is rotated an additional 90 degrees, the conductor returns to being parallel with the magnetic field. Once again no flux lines cut the conductor, and voltage and current drop to zero. An additional 90-degree revolution of the conductor results in the magnetic field being reversed at the top conductor. At this point in the revolution, the maximum number of flux lines cuts the conductor at the south pole. Voltage and current are now at maximum negative values. When the conductor completes one full revolution, it returns to a parallel position with the magnetic field. Voltage and current return to zero.

The AC generator is preferably utilized not only to provide a sufficient amount of current required when the engine is operating at low speeds but also to support additional electrical accessories and components. Components of the AC generator may include a rotor, brushes, a stator, a rectifier bridge, a housing, and a cooling fan. A brief explanation of how the aforementioned components may interact is provided by way of example. It should be readily understood that specific hardware components and connections are exemplary and should not be viewed as limiting the invention. For example, alternative schemes and components may be utilized within the AC generator and/or general charging system by those skilled in the art.

The rotor may be constructed of several turns of copper wire around an iron core. In one example, metal plates may be bent over windings and located at both ends of the rotor windings. Respective poles may be designed not to come into contact with each other, but remain interlaced. When a current passes through the coil, for example, 1.5 to 3.0 amperes, a magnetic field can be produced. The strength of the magnetic field is dependent on the amount of current flowing through the coil.

The poles will preferably take on the polarity (north or south) of the side of the coil they touch. When the rotor is assembled, the poles alternate north-south around the rotor. As a result of this alternating arrangement of poles, the magnetic flux lines will move in opposite directions between adjacent poles. This arrangement provides for several alternating magnetic fields to intersect the stator as the rotor is turning. These individual magnetic fields produce a current by induction in the stationary stator windings.

In one embodiment, wires from a rotor coil may be attached to slip rings that are insulated from the rotor shaft. By way of example, the wires from the rotor coil may be attached to two slip rings. An insulated stationary carbon brush passes field current into a slip ring, then through a field coil, and back to the other slip ring. Current then passes out of a grounded stationary brush.

A field winding of the rotor can receive current through a pair of brushes that ride against the slip rings. The brushes and slip rings provide a means of maintaining electrical continuity between stationary and rotating components. The brushes may be designed to ride the surface of the slip rings on the rotor and are preferably held tight against the slip rings, for example, by spring tension provided by brush holders. In some designs, the brushes of the AC generator conduct only the field current such as 2 to 5 amperes. Carrying a low current by the brushes may contribute to a longer service life.

Direct current from the battery may be supplied to a rotating field through a field terminal and an insulated brush. The second brush is a ground brush, which may be attached to the AC generator housing. In one example, the stator may contain three main sets of windings wrapped in slots around a laminated, circular iron frame, for example. Each of the three windings may have the same number of coils as the rotor has pairs of north and south poles. Additional setup of the components may include that the coils of each winding are evenly spaced around the core. Further, the three sets of windings may alternate and overlap as they pass through the core, for instance, in order to produce a desired phase angle response.

The rotor may be fitted inside a stator. A small air gap, for example, approximately 0.015 inch, may be maintained between the rotor and the stator. This gap may allow the magnetic field of the rotor to energize all of the windings of the stator at the same time and to maximize the magnetic force.

Each group of windings may be designed to provide a path for directing current. By way of example, each group of windings may have two leads. The first lead may be reserved for the current entering the winding. The second lead may be utilized for current leaving. One of two basic means may be utilized for connecting the leads. A common method is called the wye connection. In the wye connection one lead from each winding is connected to one common junction. From this junction the other leads branch out in a Y pattern. Another method of connecting the windings is called the delta connection. The delta connection connects the lead of one end of the winding to the lead at the other end of the next winding.

Each group of windings may occupy a portion of the stator, for example, one third of the stator, or 120 degrees of the circle. As the rotor revolves in the stator, a voltage is produced in each loop of the stator at different phase angles.

Generally, automotive batteries of the electrical systems are not designed to accept or store AC voltage. Thus, for the electrical system of the vehicle to be able to use the voltage and current generated in the AC generator, the AC current needs to be converted to DC current. A split-ring commutator cannot be used to rectify AC current to DC current because the stator is stationary in the AC generator. Instead, a diode rectifier bridge may be utilized to change the current in an AC generator. Acting as a one-way check valve, the diodes switch the current flow back and forth so that it flows from the AC generator in only one direction.

When AC current reverses itself, the diode is capable of blocking current such that no current is permitted to flow. If AC voltage passes through a positively biased diode, the diode will block off the negative pulse. Hence AC current is permitted to change to a pulsing DC current.

Many AC generators comprise housings such as two-piece construction housings, for example, made from cast aluminum. In such a design, the two-piece construction can provide two end frames to support components such as the rotor and the stator. In addition, the end frames may be designed to contain additional components such as diodes, a regulator, heat sinks, terminals, and other components of the AC generator.

In some embodiments the two end pieces are referred to as the drive end housing and the slip ring end housing respectively. The drive end housing may hold a bearing to support the front of the rotor shaft. Preferably, a rotor shaft extends through the drive end housing and holds the drive pulley and cooling fan thereto. The slip ring end housing may also hold a rotor shaft support bearing. In addition, it can contain brushes and numerous electrical terminals. If the AC generator has an integral regulator, it may also be contained within the slip ring end housing.

A cooling fan is designed to preferably draw air into the AC generator through the openings at the rear of the AC generator housing. The air leaves through openings behind the cooling fan.

Many AC generators utilize circuits in operation and to produce current. In some embodiments, three principal circuits are utilized by many AC generators including: the charging circuit, the excitation circuit, and the pre-excitation circuit. In the aforementioned example, the charging circuit consists of stator windings and rectifier circuits; the excitation circuit consists of a rotor field coil and the electrical connections to the coil; the pre-excitation circuit supplies the initial current for the field coil that starts the buildup of the magnetic field.

Accordingly, for the AC generator to produce current, the field coil is designed to develop a magnetic field. The AC generator preferably creates its own field current in addition to its output current.

For excitation of the field to occur, the voltage induced in the stator is designed to rise to a point that it overcomes a forward voltage drop of at least two of the rectifier diodes. Before the diode trio can supply field current, the anode side of the diode must be at least 0.6 volt more positive than the cathode side. Thus, in one embodiment, when the ignition switch is turned on, the warning lamp current acts as a small magnetizing current through the field. This current may pre-excite the field, reducing the speed required to start its own supply of field current.

When the engine is running, the drive belt spins the rotor inside the stator windings. This magnetic field inside the rotor generates a current in the windings of the stator. Field current flowing through the slip rings to the rotor creates alternating north and south poles on the rotor.

The induced current in the stator is an alternating current because the magnetic fields are alternating. As the magnetic field begins to induce current in the stator's windings, the induced current starts to increase. The amount of current will peak when the magnetic field is the strongest. As the magnetic field begins to move away from the stator windings, the amount of current will start to decrease.

It is desirable to protect the battery and the rest of the electrical system from excessive voltages. Thus, to prevent early battery and electrical system failure, regulation of the charging system may be important. Another consideration may including ensuring that the charging system supply enough current to run the vehicle's electrical accessories when the engine is running.

AC generators do not require current limiters, because they limit their own current output. Current limit is the result of the constantly changing magnetic field because of the induced AC current. As the magnetic field changes, an opposing current is induced in the stator windings. The inductive reactance in the AC generator limits the maximum current that the AC generator can produce. Even though current (amperage) is limited by its operation, voltage is not. For example, The AC generator is capable of producing as high as 250 volts, if it were not controlled.

Regulation of voltage is done by varying the amount of field current flowing through the rotor. The higher the field current, the higher the output voltage. For example, by controlling the amount of resistance in series with a field coil, one may control the field current and the AC generator output. In some applications, to insure a full battery charge, and operation of accessories, regulators are set for a system voltage between 13.5 and 14.5 volts.

If sensing voltage is below the regulator setting, an increase in charging output results by increasing field current. Higher sensing voltage will result in a decrease in field current and system output. A vehicle being driven with no accessories on and a fully charged battery will have a high sensing voltage. The regulator will reduce the charging voltage, and current, until it is at a level to run the ignition system while trickle charging the battery (2 to 4 amperes, for example). If a heavy load is turned on (such as the headlights) the additional draw will cause a drop in the battery voltage. The regulator will sense this low system voltage and will reduce the field circuit resistance. This will allow more current to the field windings. With the increase of field current, the magnetic field is stronger and AC generator output is increased. When the load is turned off, the regulator senses the rise in system voltage and cuts back the amount of field current and ultimately AC generator output.

Another input that may affect regulation is temperature. Because ambient temperatures influence the rate of charge that a battery can accept, regulators may be temperature compensated. Temperature compensation is desirable because the battery may be more reluctant to accept a charge at lower ambient temperatures. Thus, the regulator can be designed to increase the system voltage until it is at a high enough level that the battery will accept it.

To properly test and service the charging system, it may be important to identify the field circuit being used. In one embodiment, automobile manufacturers may typically use three basic types of field circuits. The first type is called the A circuit. It has the regulator on the ground side of the field coil. The B+ for the field coil is picked up from inside the AC generator. By placing the regulator on the ground side of the field coil, the variable resistance will allow the control of field current by varying the current flow to ground. A resistance can be located anywhere in the series circuit and have the same effect. The second type of field circuit is called the B circuit. In this case, the voltage regulator controls the power side of the field circuit. Also the field coil is grounded from inside the AC generator. The third type of field circuit is called the isolated field. The AC generator has two field wires attached to the outside of the case. The voltage regulator can be located on either the ground (A circuit) or on the B+ (B circuit) side.

Many manufacturers install the voltage regulator internally in the AC generator. This eliminates some of the wiring needed for external regulators. The diode trio rectifies AC current from the stator to DC current that is applied to the field windings.

On many vehicles after the mid-1980s, the regulator function has been incorporated into the vehicle's engine computer. The operation is the same as the internal electronic regulator. Regulation of the field circuit is typically performed through a ground circuit. A logic board's decisions, concerning voltage regulation, are based on output voltages and battery temperature. When the desired AC generator output voltage is obtained (for instance, based on battery temperature) the logic board duty-cycles a switching transistor. This transistor grounds the AC generator's field to control output voltage.

Basic methods of informing a driver of the condition of the charging system may include using indicator lamps, an electronic voltage monitor, an ammeter, and a voltmeter.

Most indicator lamps operate on the basis of opposing voltages. If the AC generator output is less than battery voltage, there is an electrical potential difference in the lamp circuit and the lamp will light. In the electromechanical regulator system, if the stator is not producing a sufficient amount of current to close the field relay contact points the lamp will light. If the voltage at the battery is equal to the output voltage, the two equal voltages on both sides of the lamp result in no electrical potential and the lamp goes out

The electronic voltage monitor module may be used to monitor the system voltage. In this set-up, the indicator lamp may be configured to remain off if the system voltage is above a prescribed point such as 11.2 volts, for example. Once system voltage drops below 11.2 volts, a transistor amplifier in the module turns on the indicator lamp. This system can use either a lamp or a light-emitting diode.

In place of the indicator light, some manufacturers may install an ammeter. The ammeter is wired in series between the AC generator and the battery. Most ammeters work on the principle of d'Arsonval movement. The movement of the ammeter needle under different charging conditions is illustrated. If the charging system is operating properly, the ammeter needle will remain within the normal range. If the charging system is not generating sufficient current, the needle will swing toward the discharge side of the gauge. When the charging system is recharging the battery, or is called on to supply high amounts of current, the needle deflects toward the charge side of the gauge. It is generally normal for the gauge to read a high amount of current after initial engine start up. As the battery is recharged, the needle should move more toward the normal range.

Because the ammeter may be seen as a complicated gauge for some users to understand, manufacturers may utilize a voltmeter to indicate charging system operation. The voltmeter is usually connected between the battery positive and negative terminals. For example, when the engine is started, it is normal for the voltmeter to indicate a reading typically between 13.2 and 15.2 volts. If the voltmeter indicates a voltage level that is below 13.2, it may mean that the battery is discharging. If the voltmeter indicates a voltage reading that is above 15.2 volts, the charging system is overcharging the battery. The battery and electrical circuits can be damaged as a result of higher than normal charging system output.

Another component which may prove to be relevant in determining diagnostic problems in a vehicle starting and charging system may include an automotive starter device. Such problems indicated by a starter motor failure may include a variety of systems. For example, when the key is turned to a START position within a vehicle, the operator may hear a pronounce click or even nothing at all. Perhaps the headlights are on and are bright but do not dim when the key is turned to the START position. Yet, every other electrical component may appear to be working fine. While a bad starter neutral switch or a bad key switch may be responsible, it may also be determined that a bad starter or a starter solenoid is the culprit.

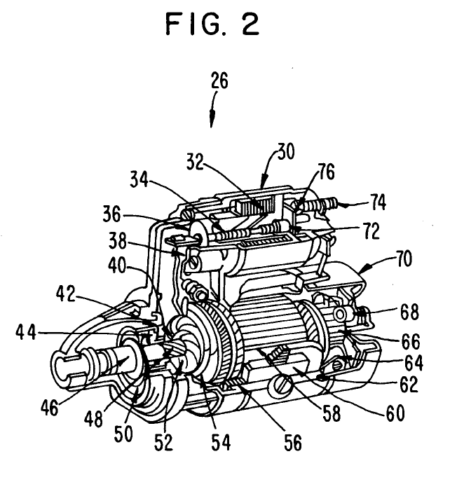

FIG. 2 illustrates an example of a starter motor assembly 26. The components of the starter motor assembly 26 may include: solenoid 30, solenoid windings 32, solenoid plunger return spring 34, solenoid plunger 36, shift lever 38, meshing spring 40, brake disc 42, driver 44, pinion gear 46, armature shaft 48, overrunning clutch 50, stop 52, guide ring 54, field winding 56, armature 58, pole piece 60, starter housing 62, brush 64, commutator 66 brush spring 68, starter end frame 70, moving contact point 72, battery terminal 74 and contact point 76. Given the multitude of components located within the starter motor assembly 26, it is possible that a problem may develop from a variety of mechanisms located within the machinery thereof. Such problems could further affect the operation of a starting and charging system of a vehicle.

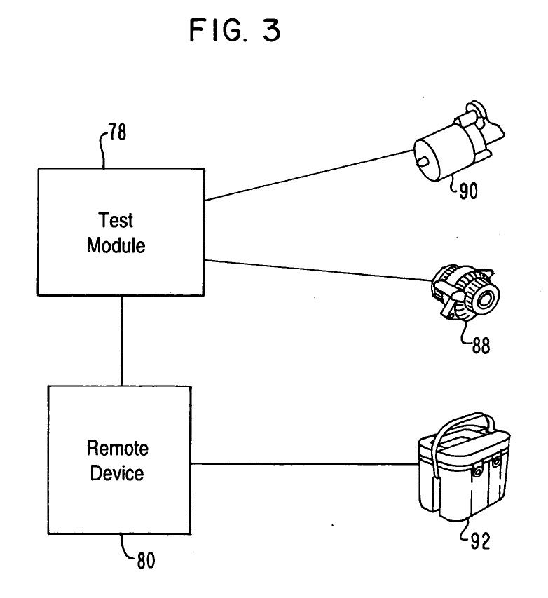

The test module 78 of the present invention (also considered as a pinpoint test module) in some embodiments is considered to be a “smart” module capable of controlling the alternator field current and making the required voltage and current measurements at given test points in a starting and charging system of a vehicle. As shown in FIG. 3, the test module 78 may be capable of communicating with a remote device 80 such as a battery tester, a scan tool, a personal computer (PC) or a personal digital assistant (PDA).

In a preferred embodiment, the test module 78 provides a communications port to receive database information which may reside in the remote device 80. Such data may be provided, for instance, via user interface of the remote device 80. Thus, a connection may be established between the communications port of the test module 78 and the user interface of the remote device 80. The aforementioned connection may include a variety of connecting means including, for example, a serial port connection, a parallel port connection, a USB connection, or a wireless interface connection.

In connection with the remote device 80, the test module 78 may be further coupled to a starter 90 and an alternator 88. Power to the test module 78 may be drawn from the remote device 80 in connection with a battery source 92 such as a battery of a vehicle.

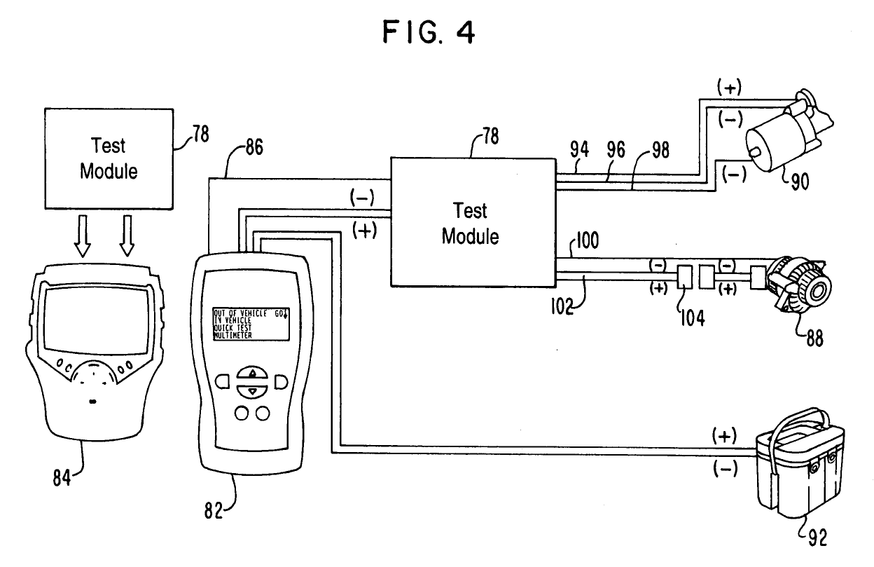

Turning to FIG. 4, the test module 78 is shown in connection with a battery tester device 82 functioning as a remote device 80. One method of connecting the test module 78 to the battery tester device 82 may include using a serial cable connection 86. As previously mentioned, the test module 78 may include alternate configurations for communicating with various interfaces of remote devices 80. For example, the test module 78 may comprise a plug in design interface capable of being received by a scan tool 84.

The test module 78 preferably includes a hardware design which utilizes a plurality of connectors to link to the starter 90 and/or alternator 88. In one embodiment, the connectors may include four test leads 94, 96, 98, 100 and an alternator lead 102 with a universal connector 104 for alternator adapter cables. In a preferred embodiment, the test module 78 is capable of measuring up to approximately 40 Volts DC from each of the leads with respect to the battery source 92 such (as a negative battery terminal for a vehicle).

A general description of the test module 78 being implemented to perform an alternator test includes disconnecting the alternator 88 from the vehicle and connecting it to the test module 78 using proper adapter cables for that vehicle. The test module 78 comprises a built-in voltage regulator for controlling the field current to the alternator for vehicles that have an external regulator. The test module 78 is capable of providing the proper signal to the alternator that has a built-in regulator to control the field current. Furthermore, the test module 78 is capable of measuring the voltage at the output terminal of the alternator and the voltage difference between the alternator output terminal and the positive battery terminal.

By obtaining the voltage difference in the prescribed manner using the test module 78 of the present invention, the integrity of the wiring and/or connections between the alternator and the battery may be checked. For example, a large voltage drop measured from the alternator to the battery by the test module 78 can indicate that the connections may be bad and/or that there may be a significant number of bad wiring strands in a cable hook-up. In another example, an operator may determine that there is a total wiring problem, for instance, if the test module 78 indicates voltage is produced from the alternator and no voltage is measured from the battery.

A general description of the test module 78 being implemented to perform a starter test includes measuring the voltage at the solenoid terminals and the starter terminal. The test module 78 is capable of measuring the voltage difference between the starter ground and the battery negative terminal. Additionally, the test module 78 is capable of measuring the difference in voltage between the battery positive terminal and the starter terminal or the solenoid terminal. The aforementioned processes for measuring the voltage differences related to the solenoid via the test module 78 may facilitate determining the state of the starter being tested and the wiring and/or connectors from the battery to the starter.

Additional parameters of the test module 78 include an ability to measure voltages with approximately a minimum accuracy of 20 mV and a minimum resolution of 10 mV. In a preferred embodiment, the test module 78 comprises low level software for computing the voltage measurements and controlling the field current to the alternator. Additionally, an ability to receive user interface software and data base information from the remote device 80 will reside in the test module 78.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An apparatus configured for testing a vehicle starting and charging system comprising:
a test module capable of identifying problems at an electrical component level within the vehicle starting and charging system, the test module includes a built-in voltage regulator to control field current and a low level software for making voltage and current measurements of the vehicle starting and charging system; and
a diagnostic device connected to the test module, wherein the diagnostic device is directly connected to a battery, wherein the battery having a positive terminal and a negative terminal.

2. (canceled)

3. The apparatus of claim 32, wherein the built-in voltage regulator controls field current to the alternator for vehicles that have an external voltage regulator.

4. (canceled)

5. The apparatus of claim 3, wherein the test module further comprises:
a plurality of test leads for connecting with the electrical component and
an alternator lead with a universal connector for an alternator adapter cable.

6. (canceled)

7. The apparatus of claim 5, wherein the test module measures approximately up to 40 Volts DC from each of the leads with respect to the battery negative terminal.

8. The apparatus of claim 32, wherein the test module measures voltage at a solenoid terminal and a starter terminal of the starter motor assembly.

9. The apparatus of claim 32, wherein the test module measures a voltage difference between a starter ground of the starter motor assembly and the battery negative terminal.

10. The apparatus of claim 32, wherein the test module measure a voltage difference between the battery positive terminal and a starter terminal of the starter motor assembly.

11. The apparatus of claim 32, wherein the test module measure a voltage difference between the battery positive terminal and a solenoid terminal of the starter motor assembly.

12. The apparatus of claim 1, wherein the test module measures voltage with a minimum accuracy of 20 mV and a minimum resolution of 10 mV.

13. The apparatus of claim 1, wherein the diagnostic device comprises user interface software and/or data base information.

14. The apparatus of claim 13, wherein the test module communicates with the diagnostic device to receive information provided via the user interface software and/or data base information residing in the diagnostic device.

15. The apparatus of claim 1, wherein the diagnostic device comprises one of a scan tool, a battery tester, a personal computer and a personal digital assistant.

16. The apparatus of claim 1, wherein the diagnostic device is connected to the test module via one of a serial port connection, a parallel port connection, a USB port connection, and a wireless interface connection.

17. (canceled)

18. The apparatus of claim 1, wherein the test module draws power from the power source through the diagnostic device connection.

19. A method of testing a vehicle starting and charging system comprising:
providing a test module capable of identifying problems at an electrical component level within the vehicle starting and charging system, the test module having a built-in voltage regulator to control field current and a low level software for making voltage and current measurements of the vehicle starting and charging system;
connecting the test module to a diagnostic device;
connecting the diagnostic device directly to a battery, such that the battery having a positive terminal and a negative terminal; and
connecting the vehicle starting and charging system to the test module.

20. The method of claim 36, further comprising:
regulating a field current to the alternator via the test module.

21. (canceled)

22. The method of claim 36, further comprising:
utilizing the test module to measure voltage at a solenoid terminal and a starter terminal of the starter motor assembly.

23. (canceled)

24. The method of claim 36, further comprising:
measuring a voltage difference between a starter ground of the starter motor assembly and the battery negative terminal.

25. The method of claim 36, further comprising:
measuring a voltage difference between the battery positive terminal and a starter terminal of the starter motor assembly.

26. The method of claim 19, wherein the diagnostic device comprises user interface software and/or data base information.

27. The method of claim 26, further comprising:
utilizing the test module to communicate with the diagnostic device to receive information provided via the user interface software and/or data base information residing in the diagnostic device.

28. The method of claim 19, further comprising:
powering the test module through the diagnostic device.

29. A system for testing a vehicle starting and charging system comprising:
means for testing the vehicle starting and charging system by identifying problems at an electrical component level of the vehicle starting and charging system, wherein the means for testing includes a built-in voltage regulator to control field current and a low level software for making voltage and current measurements of the vehicle starting and charging system;
means for connecting the testing means to a diagnostic device;
means for powering the testing means by directly connecting the powering means to the diagnostic device; and
means for connecting the vehicle starting and charging system to the testing means.

30. The system of claim 29, wherein the testing means comprises a smart test module.

31. The system of claim 29, wherein the testing means is powered by the powering means through the diagnostic device.

32. The apparatus of claim 1, wherein the electrical component is an alternator, a regulator, a wiring connection, or a starter motor assembly.

33. The apparatus of claim 1, wherein the test module is capable of controlling the field current and providing a proper signal to an alternator having a built-in regulator.

34. The apparatus of claim 32, wherein the testing module measures voltage difference between the alternator and the and the positive battery terminal.

35. The apparatus of claim 32, wherein the testing module measures voltage difference between the alternator, the regulator, and the wiring connection.

36. The method of claim 19, wherein the electrical component is an alternator, a regulator, a wiring connection, or a starter motor assembly.

37. The system of claim 29, wherein the electrical system comprises an alternator, a regulator, a wiring connection, or a starter motor assembly.
